(19) United States
(12) Patent Application Publication
(10) Pub. No.: US 2002/0181557 A1
(43) Pub. Date: Dec. 5, 2002

(54) Communication terminal apparatus and demodulation method

(76) Inventor: Hideo Fujii, Yokosuka-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/148,015

(22) PCT Filed: Sep. 27, 2001
(86) PCT No.: PCT/JP01/08416

(30) Foreign Application Priority Data
Sep. 27, 2000 (JP) 2000-294644

(51) Int. Cl. H04B 1/707

(52) U.S. Cl. 375/147

(57) ABSTRACT

Channel estimating section 102 calculates a channel estimation value by calculating the correlation between a basic code and midamble of a receiving baseband signal and therefore, creates a delay profile. User determining section 104 selects, with reference to delay profile, a user, as a user used in matrix manipulation for cancelling interference, whose maximum receiving power value exceeds a user determining threshold. Path selecting section 107, referring to delay profile, selects a path, as a path used in the matrix manipulation for cancelling interference, whose receiving power exceeds a path selection threshold value. JD demodulating section 108 generates a matrix by carrying out predetermined processing using the channel estimation value of a path selected by path selecting section 107 of a user selected by user determining section 104 and multiplies the generated matrix by a received baseband signal. Accordingly, it is possible to reduce the amount of joint detection calculation while preventing as much as possible the performance deterioration.

### TECHNICAL FIELD

The present invention relates to a communication terminal apparatus and demodulation method using matrix manipulation to demodulate a receiving signal in a radio communication system utilizing CDMA (Code Division Multiple Access) technique.

### BACKGROUND ART

Joint Detection (hereinafter referred to as “JD”) is a method to demodulate a receiving signal.

The description of such a JD method is indicated in (“Interference Cancellation vs. Channel Equalization and Joint Detection for the Downlink of C/TDMA Mobile Radio Concepts”, Bernd Steiner, Proceedings of EPMCC Conference Germany 1997, No.145, pp.253-260) or (“EFFICIENT MULTI-RATE MULTI-USER DETECTION FOR THE ASYNCHRONOUS WCDMA UPLINK”, H. R. Karimi, VTC'99, pp.593-597), etc.

JD is a demodulating method in which matrix manipulation is carried out using a system matrix that obtained by regularly arranging results of calculating the convolution of a spreading code assigned to each user and a channel estimation of each user, and by multiplying the matrix manipulation result by a data portion of a received signal, the demodulation signal is obtained after cancelling several kinds of interference such as interference due to multipath fading, inter-symbol interference and multiple access interference.

As a result, recently, JD has attracted attention because it possesses a feature that reliability of demodulation data is higher than that of the RAKE combining being generally used.

However, since the strategy adopted by conventional JD is to calculate the convolution of all user's channel estimation values and all user's assigned spreading codes, there is a weak point of enlarging the apparatus size. Therefore, a certain measure must be considered in case of using the JD in a communication terminal apparatus that greatly requires its miniaturization and lightweighting.

### DISCLOSURE OF INVENTION

It is an object of the present invention to provide a communication terminal apparatus and demodulation method in which an amount of calculation can be reduced while preventing performance deterioration as much as possible.

The aforementioned object can be achieved by measuring, in the communication terminal apparatus, the receiving power of signals transmitted from base station to each user, and excluding the JD component of a user whose maximum value of receiving power does not satisfy a predetermined threshold based on a maximum value of receiving power of the communication terminal apparatus and predetermined threshold.

### BRIEF DESCRIPTION OF DRAWINGS

FIG. 1 is a view showing a slot structure of a signal transmitted to a communication terminal apparatus according to Embodiment 1 of the present invention;

FIG. 2 is a graph illustrating a delay profile generated in a communication terminal apparatus according to Embodiment 1 of the present invention;

FIG. 3 is a block diagram showing a configuration of a communication terminal apparatus according to Embodiment 1 of the present invention;

FIG. 4 is a view showing a slot structure of a signal transmitted to a communication terminal apparatus according to Embodiment 2 of the present invention; and

FIG. 5 is a block diagram showing a configuration of a communication terminal apparatus according to Embodiment 2 of the present invention.

### BEST MODE FOR CARRYING OUT THE INVENTION

In a radio communication system, in general, aiming at increasing the channel capacity while a base station apparatus and each communication terminal apparatus are able to obtain desired receiving quality, transmission power control is carried out to maintain receiving quality at a fixed level. However, transmission power of the signal transmitted to each communication terminal apparatus from the base station apparatus is changed according to distances between apparatuses and propagation environments. In addition, the desired signal which is transmitted from the base station apparatus to a respective communication terminal apparatus (user) with large power is not affected by interference of signals with small power transmitted to other apparatuses. This point motivates the present inventor(s) to reach the present invention.

In other words, a gist of the present invention is that the communication terminal apparatus measures the receiving power of a signal transmitted from a base station apparatus to each user, and excludes JD component of a user whose maximum value of receiving power does not satisfy a predetermined threshold based on a maximum value of receiving power of the communication terminal apparatus and predetermined threshold.

Embodiments of the present invention will be described below specifically with reference to accompanying drawings.

(Embodiment 1)

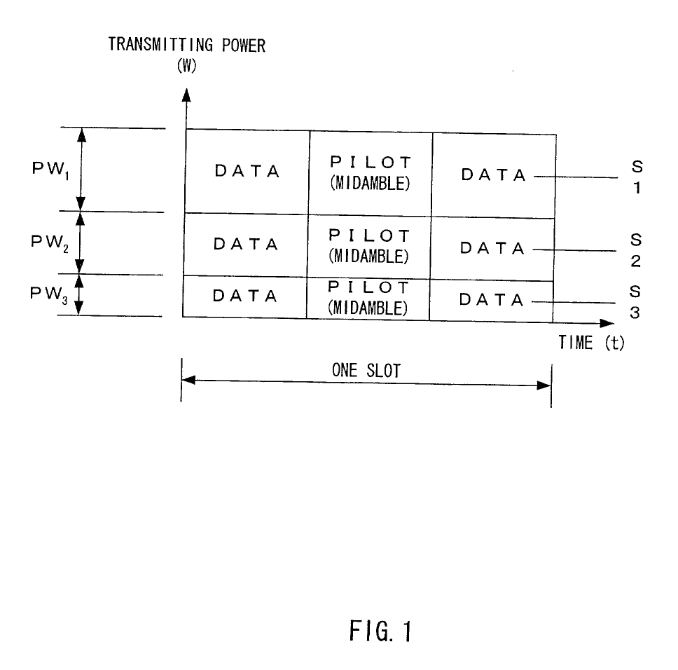

First, referring to FIG. 1, a slot structure of a signal transmitted to a communication terminal apparatus according to Embodiment 1 of the present invention will be described. FIG. 1 shows the case where a base station apparatus performs radio communications with users 1-3. As shown in FIG. 1, a signal Si transmitted to each user i (i=1, 2, 3) from the base station apparatus has the slot structure in which a pilot symbol as a known signal is inserted between data thereof. Additionally, in an actual radio communication, a guard time is set between slots.

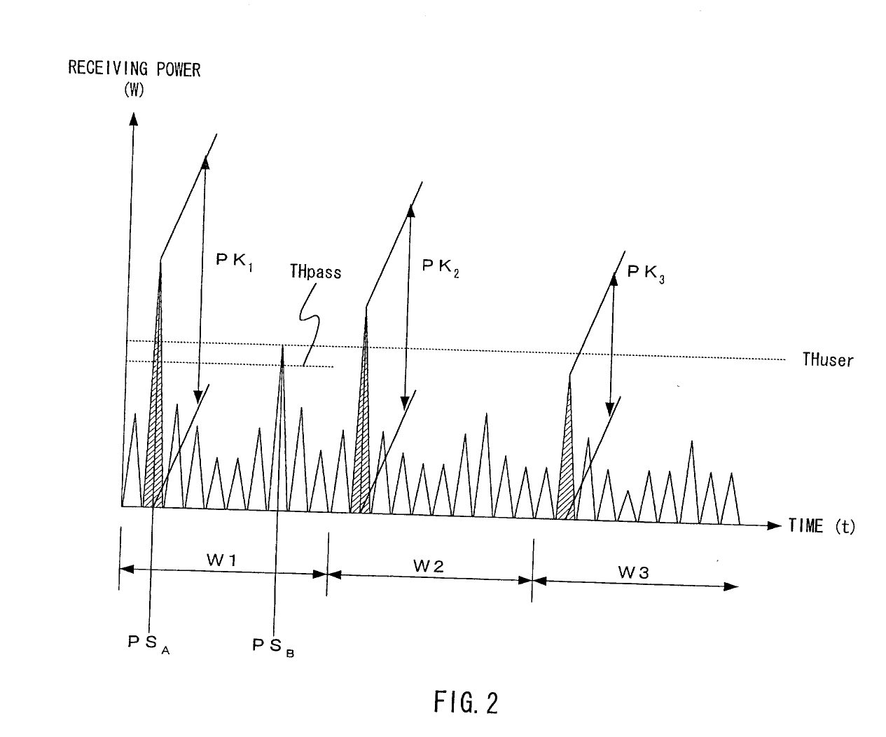

It is desirable to adopt midamble as a pilot symbol. Midamble is generated by shifting a known basic code that is repeated every predetermined chip period by a predetermined chip unit. In the receiving side, a channel estimation value which is a value that indicates an amount of phase rotation and amount of amplitude variation in a radio propagation path is computed by calculating the correlation between the midamble portion of receiving signal and a basic code, and the receiving power which is the square sum of an in-phase component and quadrature component of the channel estimation value is continuously obtained for predetermined time interval. Hereinafter, the receiving power obtained from the channel estimation value is referred to as “estimating value power”. In the receiving side, as illustrated in the delay profile of FIG. 2, the maximum value PKᵢ of estimating value power corresponding to each user i can be detected for each range of an assumed maximum delay width Wi, and one correlation processing can perform channel estimation of all users. In addition, midamble is described specifically in Japanese Patent Application No. 11-190050.

Moreover, as shown in FIG. 1, the transmitting power PWᵢ from the base station apparatus to respective users which are controlled so that the receiving quality in each communication terminal apparatus becomes constant are different according to distances between apparatuses and propagation environments. Further, as transmitting signal power from the base station apparatus to the communication terminal apparatus is large, the maximum value PKᵢ of the estimating value power becomes large.

For instance, FIG. 1 shows the case where transmitting power PW₁ of user 1 signal is the largest whereas transmitting power PW₃ of user 3 signal is the smallest. In this case, as shown in the delay profile of FIG. 2, the maximum value PK₁ of the estimating value power corresponding to user 1 becomes the largest while maximum value PK₃ of the estimating value power corresponding to user 3 becomes the smallest.

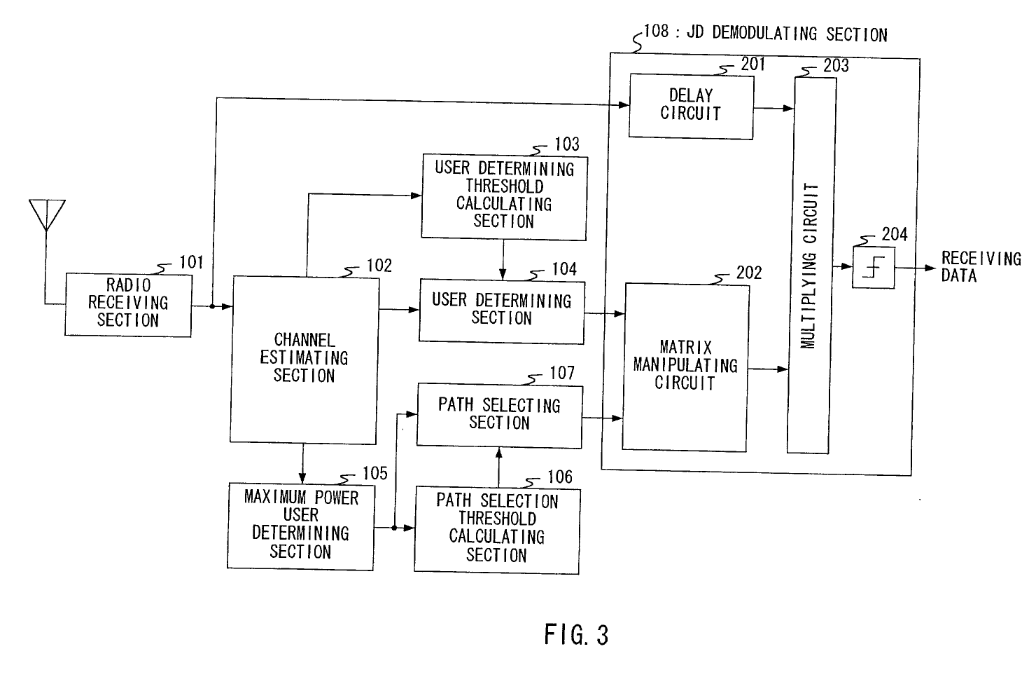

Next, a configuration of the communication terminal apparatus according to Embodiment 1 of the present invention is explained using the block diagram of FIG. 3. Moreover, the communication terminal apparatus shown in FIG. 3 corresponds to user 1 in FIG. 1 and FIG. 2.

The communication terminal apparatus shown in FIG. 3 is mainly composed of radio receiving section 101, channel estimating section 102, user determining threshold calculating section 103, user determining section 104, maximum power user determining section 105, path selection threshold calculating section 106, path selecting section 107 and JD demodulating section 108.

Radio receiving section 101 performs frequency conversion by converting the radio frequency received signal having the slot structure shown in FIG. 1 into a baseband signal. Then, radio receiving section 101 outputs the data portion of the receiving signal being converted into baseband (henceforth, it is referred to as “receiving baseband signal”) to JD demodulating section 108 and outputs the midamble portion of the receiving baseband signal to channel estimating section 102.

Channel estimating section 102 calculates a channel estimation value by calculating the correlation between a basic code and the midamble of receiving baseband signal, and hence, generates a delay profile as shown in the aforementioned FIG. 2. Then, channel estimating section 102 outputs a delay profile of the communication terminal apparatus itself to user determining threshold calculating section 103 while outputs all delay profiles to user determining section 104 and maximum power user determining section 105.

Referring to communication terminal apparatus delay profile, user determining threshold calculating section 103 sets a threshold value THᵤₛₑᵣ used for user determination based on the own-apparatus maximum value of the estimating value power. For example, the threshold THᵤₛₑᵣ is set such that a predetermined ratio of the threshold to the maximum value of the estimating value power of the communication terminal apparatus is obtained. Further, user determining threshold calculating section 103 outputs the assigned threshold THᵤₛₑᵣ to user determining section 104.

User determining section 104 selects, with reference to delay profile of the other apparatus(es), the user which utilizes matrix manipulation for cancelling interference when its maximum value of the estimating value power exceeds the threshold value THᵤₛₑᵣ. For instance, in case of the aforementioned FIG. 2, user determining section 104 selects user 1 and user 2 since maximum value PKᵢ of estimating value power thereof exceed the threshold value THᵤₛₑᵣ. Then, user determining section 104 outputs a user information that shows the selected user to JD demodulating section 108.

Maximum power user determining section 105 determines a user which has a maximum value PKᵢ of the estimating value power in the received slot (henceforth, it is referred to as “maximum power user”) with reference to the delay profile outputted from channel estimating section 102. For example, in the case of the above-mentioned FIG. 2, since maximum value PK₁ of the estimating value power is the largest, maximum power user determining section 105 determines user 1 as a maximum power user. Next, maximum power user determining section 105 outputs a delay profile of the maximum power user to path selection threshold calculating section 106 and path selecting section 107.

Path selection threshold calculating section 106 sets, with reference to the delay profile of the maximum power user, a threshold value THₚₐₜₕ used for path selection based on the maximum value of estimating value power of maximum power user. For example, corresponding to the maximum value PK₁ of the estimating value power of the maximum power user, the threshold value THₚₐₜₕ is set such that a predetermined ration of the threshold to the maximum value of the maximum power user of the communication terminal apparatus is obtained. Then, path selection threshold calculating section 106 outputs the set threshold value THₚₐₜₕ to path selecting section 107.

Path selecting section 107 selects, with reference to the delay profile of the maximum power user, the path which exceeds the threshold value THₚₐₜₕ to be used for matrix manipulation aiming at cancelling the interference. For instance, in the case of the aforementioned FIG. 2, path selecting section 107 selects path PS_{A} and path PS_{B} by which the correlation values exceed the threshold value THₚₐₜₕ. Then, path selecting section 107 outputs a position of the selected path and its respective channel estimation value to JD demodulating section 108.

JD demodulating section 108 generates a matrix by predetermined processing using the channel estimation value of the path selected by path selecting section 107 of the corresponding user selected by user determining section 104, and performs (Joint Detection) by multiplying the generated matrix by the receiving baseband signal. Next. JD demodulating section 108 executes demodulation to obtain the desired receiving data while cancelling the interference.

Next, a detailed description of an internal configuration of JD demodulating section 108 is given below. JD demodulating section 108 is mainly provided with delay circuit 201, matrix manipulating circuit 202, multiplying circuit 203 and identification circuit 204.

Delay circuit 201 delays a data portion of a receiving baseband signal to match a processing timing of multiplying circuit 203.

Matrix manipulating circuit 202 performs matrix manipulation, described next, using the path position and path channel estimation value of the path selected by path selecting section 107 of the corresponding user selected by user determining section 104.

First, calculation of the convolution between a channel estimation value of each of selected users and a respective spreading code assigned to the user is carried out, resulting in obtaining a matrix that shows the convolution calculation results. The matrix in which convolution calculation results of every user are regularly arranged, hereinafter, is referred to as a system matrix. Here, the system matrix is denoted by matrix [A] in order to simplify the explanation. Matrix manipulating circuit 202 performs matrix multiplication shown in equation (1) using a system matrix [A] and obtains matrix [B].

[B]=([A]^{H}·[A])⁻¹·[A]^{H}, (1)

where, [A]^{H} is the conjugate transpose of the system matrix and ([A]^{H}·[A])⁻¹ is the inverse matrix of [A]^{H}·[A].

Multiplying circuit 203 performs multiplication processing of matrix [B] sent from matrix manipulating circuit 202 and the data portion of the receiving baseband signal sent from delay circuit 201 after being timing-aligned. Thereby, the receiving data of own-apparatus to which interference was cancelled is obtained.

Identification circuit 204 obtains receiving data after performing a hard decision on own-apparatus receiving data outputted from multiplying circuit 203.

Thus, it is possible to reduce the amount of calculation by performing JD excluding a signal of the user whose estimating value power does not satisfy the threshold as compared to the case of processing the signals of all users, moreover, it is also possible to execute demodulation almost without degrading the performance.

Moreover, since demodulation by JD is performed also to other apparatus signals having small power which leads to a difficulty of estimating the interference, the conventional problem that a reduction of performance deterioration is proportional to performing interference cancellation well is also solvable.

(Embodiment 2)

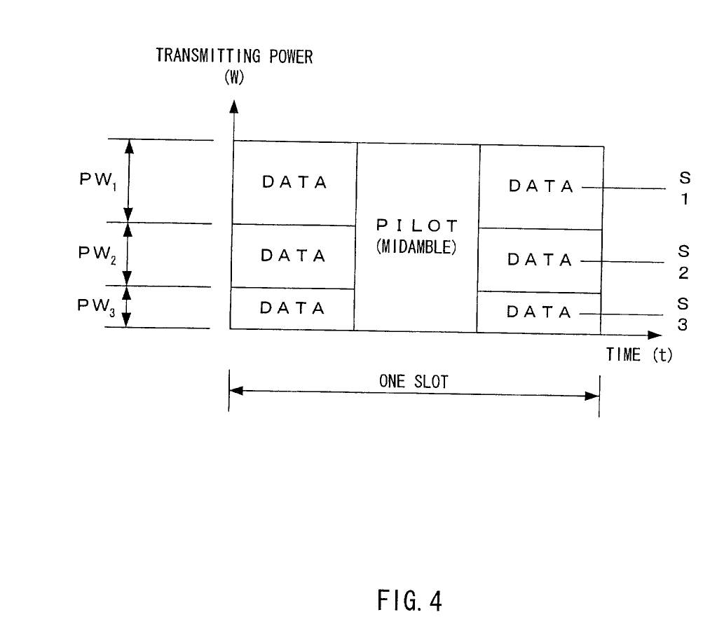

There is a case that a common midamble at a pilot symbol, as shown in FIG. 4, is adopted as a structure of a slot employed only to downlink in order to increase channel estimation accuracy, etc. However, since the receiving power of each user cannot be estimated from a delay profile when this common midamble is adopted, a problem due to the difficulty of selecting a user which utilizes matrix manipulation for cancelling the interference is generated when applying the method indicated in Embodiment 1.

In Embodiment 2, the aforementioned problem is to be solved and the user which utilizes matrix manipulation for cancelling the interference is selected even when adopting common midamble, then, the case where performing Joint Detection is described.

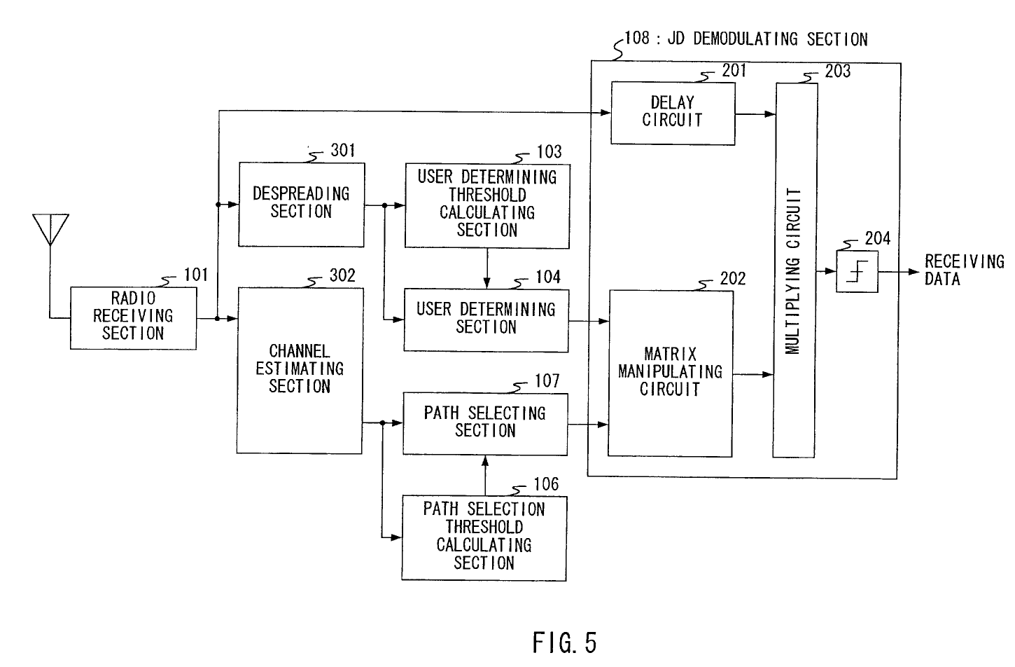

FIG. 5 is a block diagram showing a configuration of a communication terminal apparatus according to Embodiment 2 of the present invention. In addition, the components of communication terminal apparatus shown in FIG. 5 similar to those corresponding components of the communication terminal apparatus shown in FIG. 3 are assigned the same reference numerals and descriptions thereof are omitted.

Comparing to the communication terminal apparatus shown in FIG. 3, the communication terminal apparatus shown in FIG. 5 is further provided with a despreading section 301 while maximum power user determining section 105 is deleted. Moreover, operation of channel estimating section 302 of the communication terminal apparatus shown in FIG. 5 differs from that of channel estimating section 102 of the communication terminal apparatus shown in FIG. 3.

Radio receiving section 101 outputs the data portion of the receiving baseband signal to despreading section 301 and JD demodulating section 108 whereas outputs the midamble portion of the receiving baseband signal to channel estimating section 302.

Despreading section 301 measures the receiving power by performing the correlation between the data portion of the receiving baseband signal and spreading code which has been multiplied by each user's data portion at a base station apparatus side, outputs the data portion receiving power of its own-apparatus to user determining threshold calculating section 103 and outputs data portion receiving power of other apparatus to user determining section 104.

User determining threshold calculating section 103 sets a threshold to be used for user determining based on the data portion receiving power of the communication terminal apparatus and outputs the set threshold used for user determining to user determining section 104.

User determining section 104 selects a user used in matrix manipulation for cancelling the interference whose data portion receiving power exceeds the user determining threshold and outputs user information that shows the selected user to JD demodulating section 108.

Channel estimating section 302 creates a delay profile by calculating the correlation between the basic code and the midamble of the receiving. baseband signal and outputs the created delay profile to path selection threshold calculating section 106 and path selecting section 107.

Path selection threshold calculating section 106 sets a threshold for path selection based on the maximum value of estimating value power with reference to the delay profile and outputs the assigned threshold value for path selection to path selecting section 107.

Path selecting section 107 selects, referring to the delay profile, a path which is used in matrix manipulation for cancelling the interference and which exceeds the threshold value used for path selection and outputs the selected path position and its corresponding channel estimation value to JD demodulating section 108.

Accordingly, by measuring the data portion receiving power of the signal transmitted from base station apparatus to each user, it is possible to select a user used in matrix manipulation for cancelling the interference even when a common midamble is adopted, hence, it is also possible to obtain the same effect as that of the aforementioned Embodiment 1.

Moreover, although the communication terminal apparatus of both aforementioned embodiments execute demodulation using JD, the present invention is not limited to this, and the same effect can be obtained when executing demodulation using other matrix manipulation.

As is clear from the foregoing, according to the present invention, a communication terminal apparatus measures receiving power of signal transmitted from base station apparatus to each user and excludes JD component of the signal whose receiving power does not satisfy a predetermined threshold value, and it is thereby possible to reduce the amount of JD calculation with almost no performance deterioration caused.

The present application is based on the Japanese Patent Application No. 2000-294644 filed on Sep. 27, 2000, entire content of which is expressly incorporated by reference herein.

### INDUSTRIAL APPLICABILITY

The present invention is applicable to a communication terminal apparatus of a radio communication system based on CDMA technique.

1. A communication terminal apparatus comprising:
channel estimating means for calculating a channel estimation value of each user using a known signal included in a receiving signal;
user determining means for selecting a user used in matrix manipulation based on receiving power; and
demodulating means for carrying out matrix manipulation using channel estimation value of the user selected by said user determining means and demodulating a data portion of the receiving signal.

2. The communication terminal apparatus according to claim 1, further comprising path selecting means for selecting a path used in the matrix manipulation with reference to a delay profile, wherein said demodulating means carries out the matrix manipulation using a channel estimation value of the path selected by said selecting means of the user selected by said user determining means.

3. The communication terminal apparatus according to claim 2, wherein said path selecting means selects the user with a maximum value of receiving power that is the largest among maximum values, sets a first threshold based on said maximum value of receiving power of the selected user and selects a path of larger receiving power than said first threshold.

4. The communication terminal apparatus according to claim 1, wherein the demodulating means performs demodulation by joint detection.

5. The communication terminal apparatus according to claim 1, wherein said user determining means selects the user used in the matrix manipulation based on the channel estimation value calculated in said channel estimating means.

6. The communication terminal apparatus according to claim 5, wherein said channel estimating means calculates the channel estimation value by taking the correlation between said midamble included in a receiving signal whose known signal is said midamble and a basic code.

7. The communication terminal apparatus according to claim 1, further comprising despreading means for measuring the data portion receiving power of the receiving signal, wherein said user determining means selects a user used in the matrix manipulation based on receiving power measured in said despreading means.

8. The communication terminal apparatus according to claim 5, wherein said user determining means sets a second threshold value based on data portion receiving power of the communication terminal apparatus and selects a user, among users as other communication terminal apparatuses, whose data portion receiving power is larger than said second threshold.

9. A base station apparatus that carries out radio communications with a communication terminal apparatus, said communication terminal apparatus comprising:
channel estimating means for calculating channel estimation value of each user using a known signal included in a receiving signal;
user determining means for selecting a user used in the matrix manipulation based on receiving power; and
demodulating means for demodulating the data portion of the receiving signal after carrying out matrix manipulation using channel estimation value of a user selected by said user determining means.

10. A demodulating method comprising the steps of:
calculating a channel estimation value of receiving power of each user;
selecting a user of receiving power larger than a predetermined threshold value; and
demodulating a data portion of the receiving signal after carrying out matrix manipulation using the channel estimation value of said selected user.
